(19) United States
(12) Patent Application Publication
(10) Pub. No.: US 2008/0281623 A1
(43) Pub. Date: Nov. 13, 2008

(54) METHOD FOR CREATING AN EDUCATIONAL SUPPLEMENTAL PLAN

(76) Inventor: Wesley A. Snyder, Oley, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 12/118,852

(22) Filed: May 12, 2008

Related U.S. Application Data
(60) Provisional application No. 60/917,370, filed on May 11, 2007.

(51) Int. Cl. G06Q 10/00

(52) U.S. Cl. 705/1

(57) ABSTRACT

A computer-implemented method provides illustrations of college expense funding for a plurality of college students who attend an institution of higher education and who pay at least some college expenses using proceeds from parental college-related loans. The payments on the loans are reimbursed by the institution only if the student does not drop out of the institution. A computer-implemented apparatus administers a financial aid program for the students based on this methodology.

### CROSS-REFERENCE TO RELATED APPLICATIONS

This application claims the benefit of U.S. Provisional Application No. 60/917,370 filed May 11, 2007.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BRIEF SUMMARY OF THE INVENTION

A computer-implemented method provides illustrations of college expense funding for a plurality of college students who attend an institution of higher education and who pay at least some college expenses using proceeds from parental college-related loans. The payments on the loans are reimbursed by the institution only if the student does not drop out of the institution. A computer-implemented apparatus administers a financial aid program for the students based on this methodology.

### BRIEF DESCRIPTION OF THE DRAWINGS

The foregoing summary as well as the following detailed description of preferred embodiments of the invention, will be better understood when read in conjunction with the appended drawings. For the purpose of illustrating the invention, the drawings show presently preferred embodiments. However, the invention is not limited to the precise arrangements and instrumentalities shown. In the drawings:

FIGS. 1-3B show three different financial scenarios (illustrations) in accordance with preferred embodiments of the present invention.

FIGS. 4A-4B shows program data fields for use with one preferred embodiment of a software program for implementing the present invention.

FIGS. 5-6 show a schematic block diagrams of preferred embodiments of apparatus for implementing the present invention.

### DETAILED DESCRIPTION OF THE INVENTION

Certain terminology is used herein for convenience only and is not to be taken as a limitation on the present invention.

This patent application includes an Appendix having a file named appendix.txt, created on May 6, 2008, and having a size of 190,315 bytes. The Appendix is incorporated by reference into the present patent application. One preferred embodiment of the present invention is implemented via the source code in the Appendix. The Appendix is subject to the “Copyright Notice and Authorization” stated above.

One preferred embodiment of the present invention described herein is referred to as THE WISE EDUCATIONAL SUPPLEMENTAL PLAN.

One preferred embodiment of the present invention is described below.

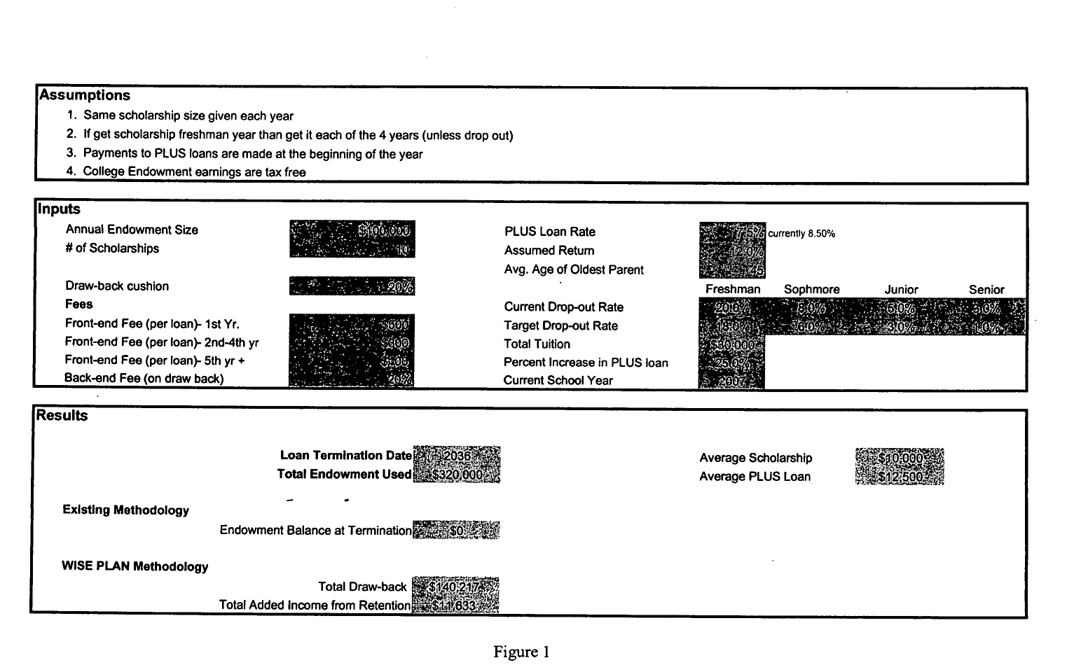

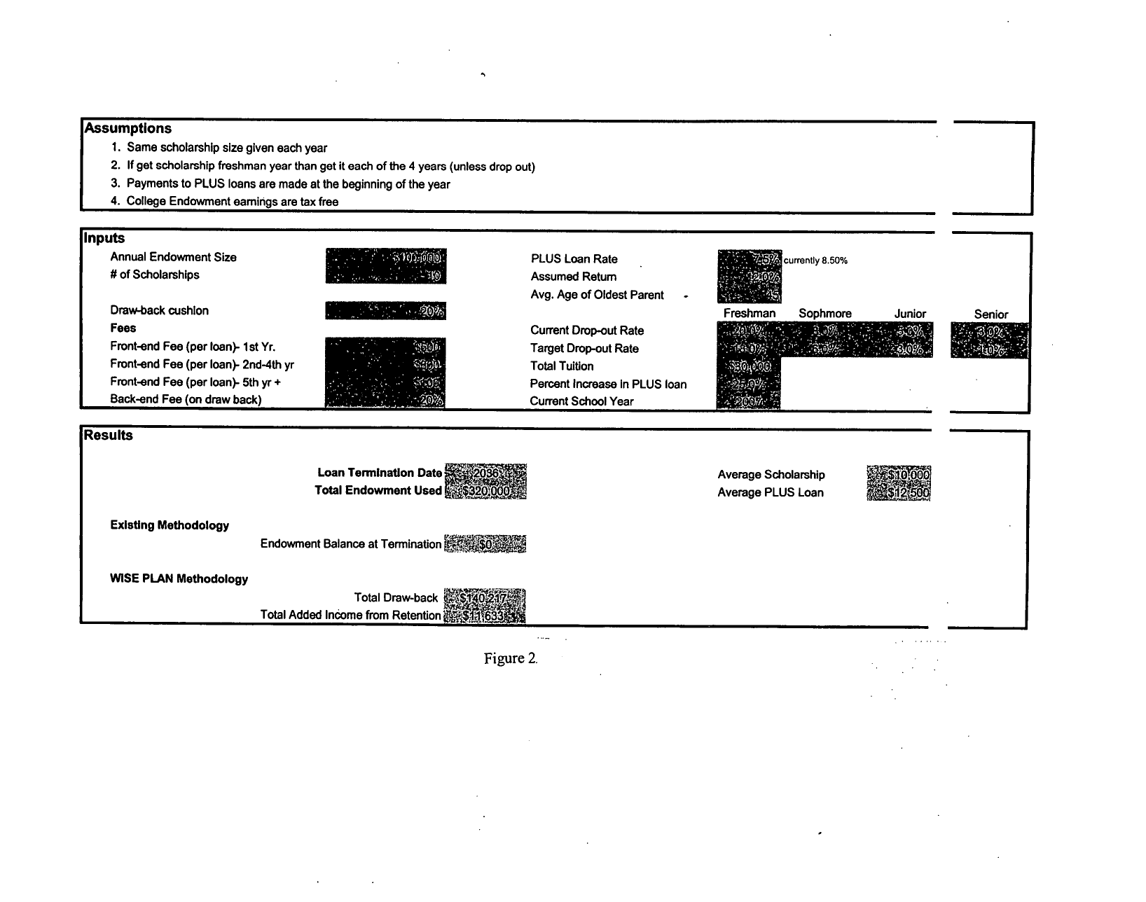

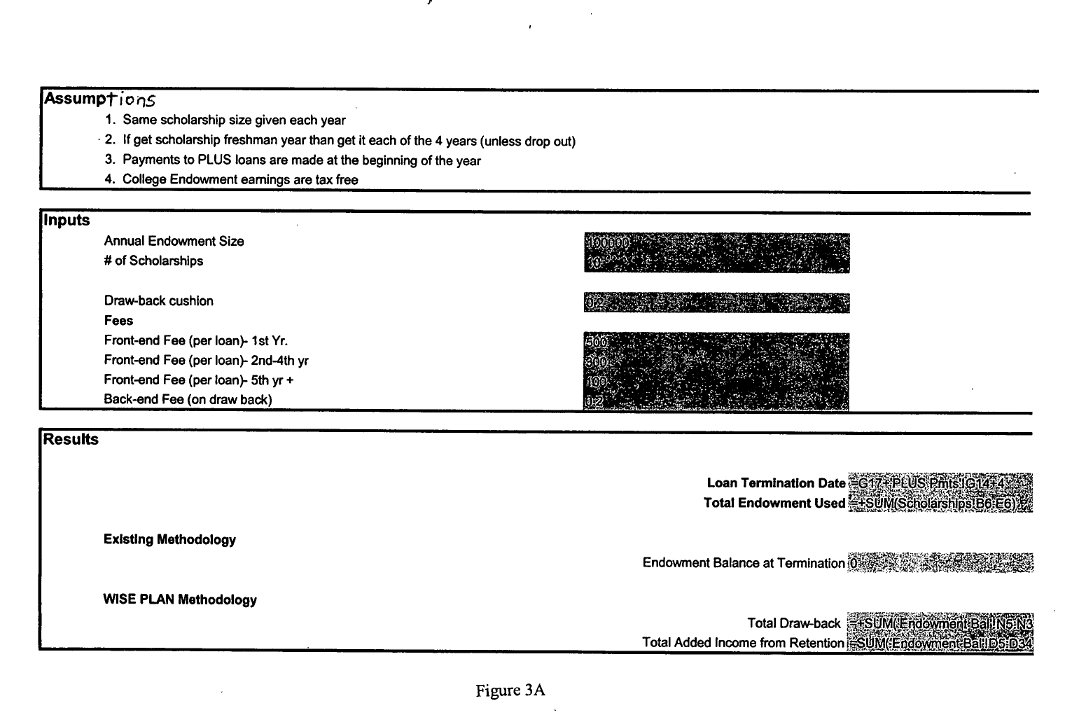

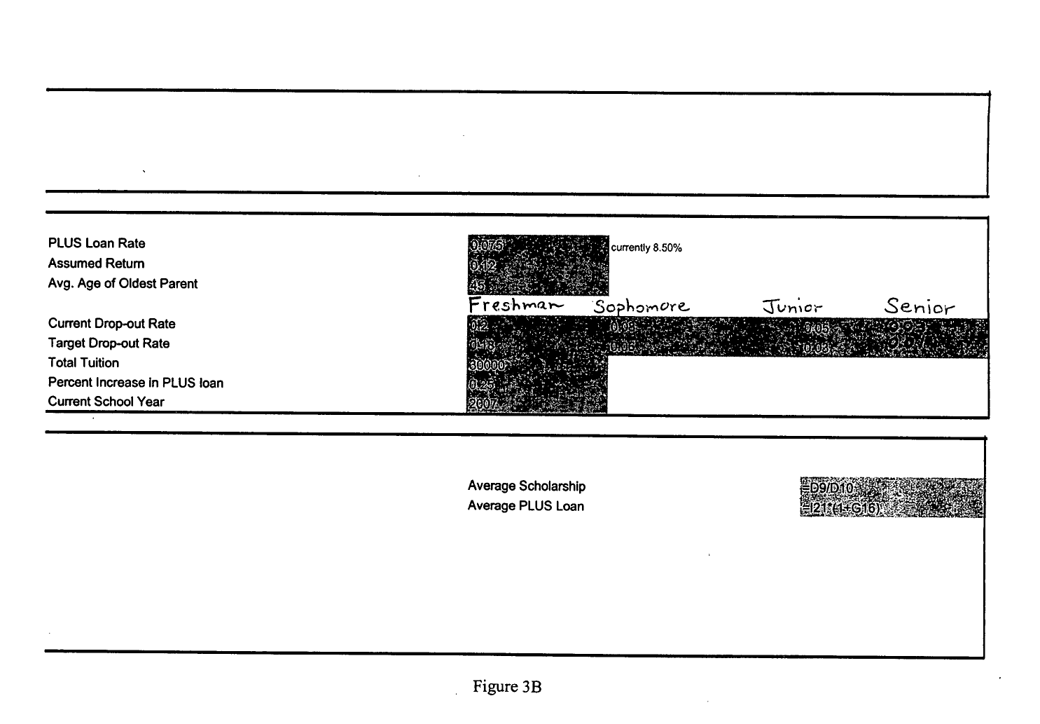

FIGS. 1-3B show illustrations of three different self-explanatory financial scenarios. Each of the scenarios has assumptions, inputs and results.

A computer-implemented method of creating a financial plan for eleemosynary individuals and organizations (also, referred to as “institutions”) projects and follows an alternative funding mechanism to more efficiently utilize the funds available for scholarships in an effort to service more students with the same funds. In one preferred embodiment, the method operates as follows:

a. Input into a computer program at least the following information:

i. the amount of funds currently being allocated for scholarships, namely, the current budget amount available for scholarships for a class year of students. This is shown in FIG. 1 as the “Annual Endowment Size.” This amount will be escrowed in a separate fund (also referred to as “Escrowed Funds”) and invested by the institution.

ii. the number of students normally provided with funds in (i), namely, the number of scholarships that the institution plans on funding. This is shown in FIG. 1 as the “# of Scholarships.”

iii. how conservative the individual or organization wants to be relative to the Escrowed funds account drawdown during the term of the plan (25 or 30 years). This is shown in FIG. 1 as the “Draw-back cushion.” This is a percent of future liabilities under the plan that is retained in the plan, analogous to a reserve requirement for banking institutions.

iv. the negotiated administrative fee of the administrator of the plan. This is shown in FIG. 1 as the “Fees.”

v. current Federal Parent Loan for Undergraduate Students (PLUS or Plus) rates which will be used to support the current college expenses. PLUS loans are described in more detail in U.S. Pat. No. 7,158,950 (Snyder), which is incorporated herein by reference. This is shown in FIG. 1 as the “PLUS Loan Rate.” The terms of such loans are incorporated within the source code of the Appendix. In alternative embodiments, other types of parental loans college-related loans offered by private or public entities may be used instead of PLUS loans.

vi. an assumed return on investment of the Escrowed Funds for the full term with the guidance of the planholder's Registered Investment Advisor. This is shown in FIG. 1 as the “Assumed Return.”

vii. the estimated average age of parents of students used in (ii) above. This is shown in FIG. 1 as the “Avg. Age of Oldest Parent.”

viii. average current dropout rates for institutions of higher learning. This is shown in FIG. 1 as the “Current Drop-out Rate.” For a plan designed for a specific institution, the dropout rates for the specific institution are preferably used. For a plan designed for an entity providing scholarships at a plurality of colleges, the average dropout rates may be used.

ix. target dropout rate for institutions of higher learning. This is shown in FIG. 1 as the “Target Drop-out Rate.”

x. (due to the potential savings in this Financial Plan) an estimated amount that the scholarships being offered might be increased as an alternative to servicing more students. This is shown in FIG. 1 as the “Percent Increase in PLUS loan.”

b. The computer program uses the above-identified inputs to determine the following items:

i. the length of the plan in years consistent with current PLUS loan regulation formulas. This is shown in FIG. 1 as the “Loan Termination Date” and is also referred to herein as the “plan termination date.”

ii. all estimated endowment funds needed over a 4-year period. This is shown in FIG. 1 as the “Total Endowment Used” and is also referred to herein as “total funds used.”

iii. the estimated endowment balance at the termination of the program. This is shown in FIG. 1 as the “Endowment Balance at Termination.”

iv. the estimated drawback cash flow schedule as calculated by the input made in item a (iii). From this schedule, the program provides the total amount that should be returned to the institution. This is shown in FIG. 1 as the “Total Draw-back.”

v. the average size supplemental plan for this class group. This is shown in FIG. 1 as the “Average Scholarship.”

vi. the average PLUS loan in the class year. This is shown in FIG. 1 as the “Average PLUS Loan.” This is the loan amounts that can be awarded based on the current budget amount.

vii. the amount of income contributed by reducing the dropout rate, not including the additional tuition and fee income resulting from the retained students. This is shown in FIG. 1 as the “Total Added Income from Retention.”

The calculations above are based upon market rate financial conditions and historical benchmarks for financial performance and college drop-out rates as determined by the schools retention program parameters.

A written investment policy statement should be formulated that is sufficiently aggressive to service the PLUS loans.

Preferably, the PLUS loans should be consolidated from time to time based on the then current consolidation rules under the Federal Parental Plus Loan Program. Loan consolidation is discussed in U.S. Pat. No. 7,158,950.

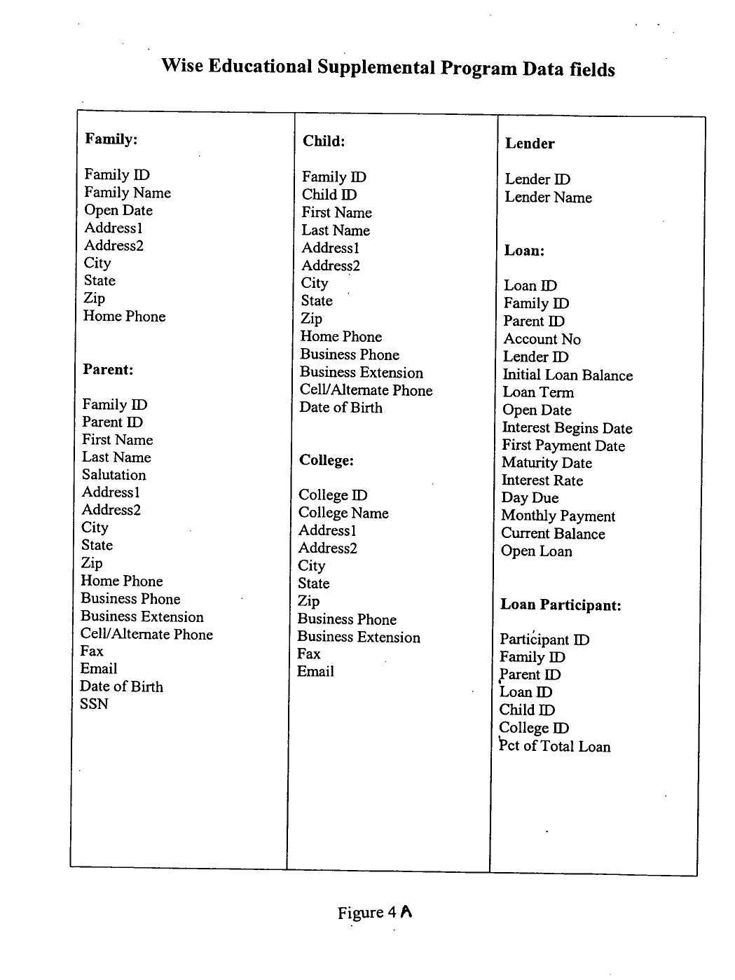

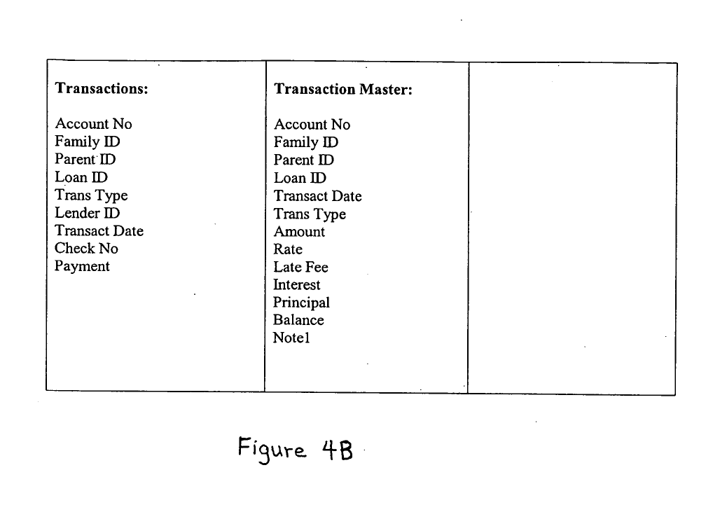

FIGS. 4A-4B shows program data fields for use with one preferred embodiment of a software program for implementing the present invention, namely, the Wise Educational Supplemental Plan.

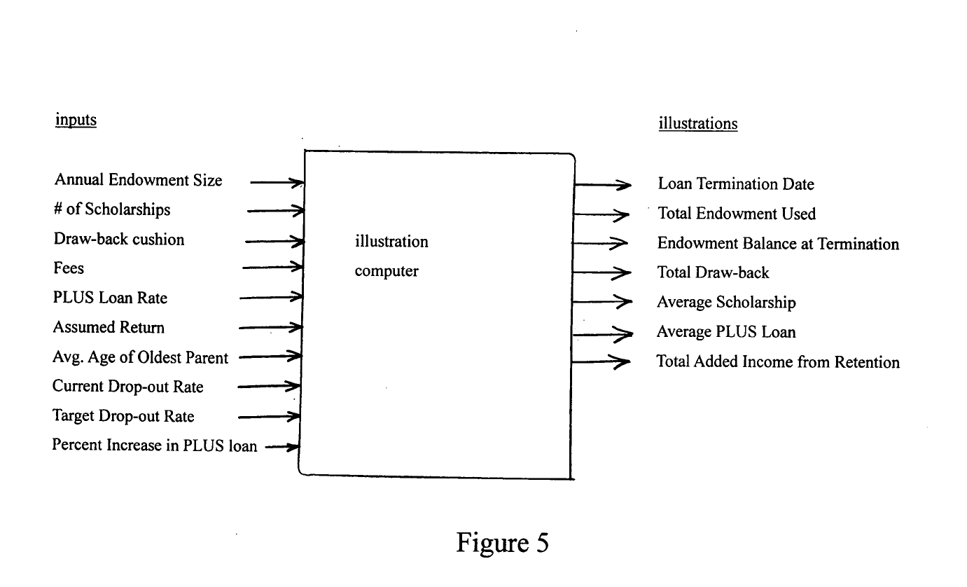

FIG. 5 shows a schematic block diagram of an apparatus for performing the above-discussed illustrations. The illustration computer in FIG. 5 may be any mainframe computer or a general-purpose computer, such as a personal computer running a Windows operating system, that can execute the type of software disclosed in the Appendix.

Users of the plan are typically colleges and universities providing scholarship aid to incoming students and upper classman. However, there can be a material reduction in costs to any organization providing scholarships to college bound students.

The program attempts to define an alternative way to support the financial needs of the benefactors and as a result, stretches the available funds of the donor to enable them to service more students with the same dollars.

The program addresses the multi-million dollar financial problem currently faced by all institutions of higher learning, that of “retention.” If retention is defined as the percentage of students an institution can retain from class to class, it is not unusual for an institution to lose more than 25% of their enrollment from the freshman to sophomore years. It is much more costly to recruit a new student than to retain a current student. If an appropriate incentive is provided, retention may be reduced.

Preferred embodiments of the present invention marry the idea of scholarship aid dependent on retention with the use of Parental Plus Loans that the institution assumes responsibility of reimbursing the parent for the payments thereon if the student continues matriculation at their institution to complete their degree.

The following scenario explains the process:

1. Student applies for admission.

2. Upon acceptance, the student applies for financial aid.

3. Today, aid my be provided from numerous sources, but the largest and best type of aid is a scholarship because it is a gift and does not need to be paid back. Assume that a gift of $10,000 is proposed.

4. As an alternative, the school offers a $12,000 “Wise Educational Supplemental Plan” with the caveat that the school will supplement the payments on a Parental Plus Loan as long as:

A. The student stays with the institution and is matriculating for a degree. That is, if the student drops out, the obligation of the institution to reimburse the student's parent is terminated.

B. Following Graduation:
1. As long as the consolidated Parental Plus Loans are serviced as agreed under the plan's terms and conditions.
2. The student is alive. (Loan is paid by government when student passes.)
3. The parent is alive. (Loan is paid by government when parent passes.)
4. The parent becomes disabled. (Loan is paid by government when parent is disabled.)

As one can see, the disability or mortality of the student or parent play a roll in reducing costs. This is often referred to as a “cancellation” or “discharge” feature.

Furthermore, the school has most of the corpus to invest until such time as payments are reimbursed to the parents for these Parental Loan payments for a time that can extend for as long as 30 years beyond graduation. This arbitrage over the net parental plus rate will repay the bonus of $2,000 in this example. As a result, the school potentially can recoup most of its original funding to be used again another day.

The software establishes an amount over current liabilities limit so that the trust fund used to house the investments will authorize the trustee to make partial disbursements prior to the end of the Parental Plus Loans if there is a sufficient surplus in the fund.

Regarding organizations other than colleges and universities using the plan, the same attributes are applicable and they would not need to bonus the scholarships to make it seem more valuable than a straight scholarship.

The software provides for quarterly reporting to the trustee of the funds of the future obligations of the trust and current market value of the funds.

Yearly fees are paid to an administrating entity for costs of administration of the program and deferred compensation based on the net results of the ultimate program.

### Additional Considerations:

A. The drawback cushion should be set sufficiently conservative so that there is very little possibility of the school or organization being in a position to further supplement the program in its later years of funding for any student.
B. A proper investment policy statement by the trustee or provider of the scholarship funds must provide for recognition that this program is designed to be more than 20 years and potentially up to 30 years in length. As a result, the first 15 to 25 years should appropriately be managed in an aggressive way to further assure positive long-term results.
C. The costs within the concept would be excessive for supplements of less than $3000, so the plan is not appropriate for small scholarship funding.
D. Funds managed appropriately should potentially pay all costs of the current supplemental program plus potentially provide the school or organization with a return of much of their original funding as seed funds for another cycle.
E. The better the plan works to solve the retention concern of the school, the more emphasis must be placed on an aggressive investment policy statement in the early years of a scholarship. However, the school will have the advantage of earning the additional tuition and fee income from the student. The program does not make any attempt to try to quantify this issue.
F. The program provides for the college to supplement their normal level of scholarship and still provide a vehicle to recoup some or all of the initial capital used in their traditional scholarship programs.
G. Because of the time available for performance in this program, below are listed some typical expected performances using a very nominal interest rate spread over program costs that might be typical for a funding organization to expect.

| Spread | Return of funds |
|---|---|
| 0.25% spread = | 50% |
| 0.50% spread = | 100% (Breakeven) |
| 0.75% spread = | 167% |
| 1.00% spread = | 240% |

As shown above, the time value of money compounding for a long time can provide many more scholarships to be funded with the same funds.

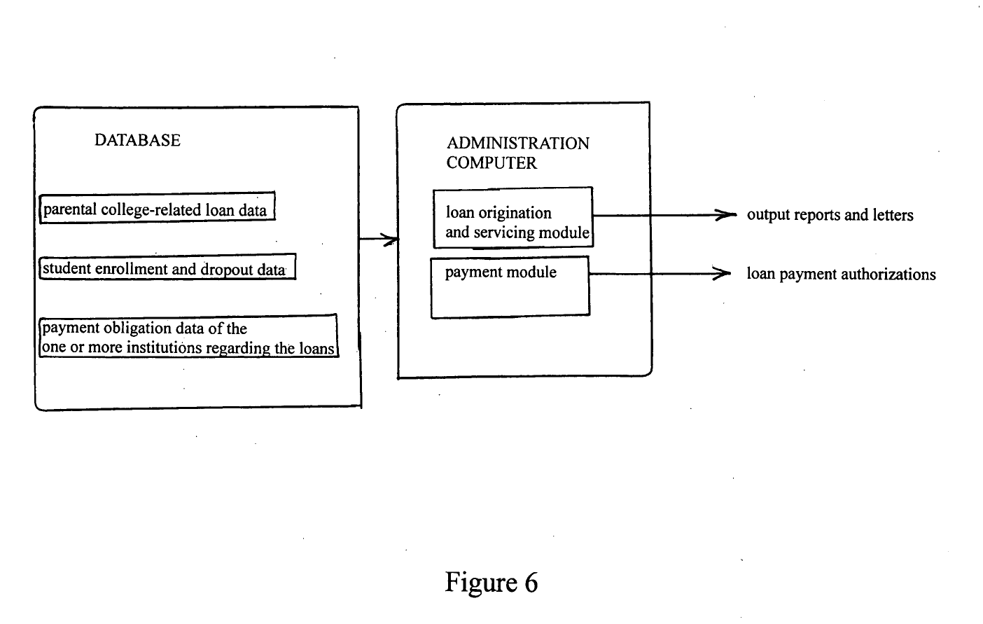

FIG. 6 shows a schematic block diagram of an apparatus for administering and servicing loan portfolios generated by the present invention. The administration computer in FIG. 6 may also be any mainframe computer or a general-purpose computer. The administration computer may service loans from one institution or from multiple institutions. Once the institution becomes obligated to make the loan payments, such as upon successful completion of a degree at the institution that the student originally matriculated into when the loan was originated, the administration computer causes the payment module to make the appropriate payments. In one preferred embodiment, the payments are made directly to the parents and the parents use the payments to pay back the loan. In another preferred embodiment, the payments are made directly to the entity that is servicing the loan. If the loan is a PLUS loan, payment could also be made directly to SallieMae® which administers the PLUS loan program.

The database in FIG. 6 includes the data fields shown in FIGS. 4A and 4B, and is populated with its data as loans are originated. The database may separate from, or part of, the administration computer. The output reports and letters in FIG. 6 include at least the following reports and letters:

1. Welcome letter
2. Telephone interview confirmation letter
3. Directions for PLUS loan application letter
a. Supplemental b. Private
   4. Request confirmation for lender correspondence forwarding
   5. Confirmation of authorized parties letter
   6. Quarterly reimbursement report
   7. Quarterly check distribution file report
   8. Quarterly cover letter for check distribution
   9. Annual reconfirmation of continued matriculation
   10. Annual comparison report—actual performance vs. projected performance—supplemental
11. Annual comparison report—actual performance vs. projected performance—private and supplemental
   12. Transaction reports of loans and payment servicing
   13. Outstanding loans for family by parent
   14. Outstanding loans for college or organization
   15. Family loan report by loan
   16. College loan reports
   17. Family loan report by college

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

While the present invention has been particularly shown and described with reference to one preferred embodiment thereof, it will be understood by those skilled in the art that various alterations in form and detail may be made therein without departing from the spirit and scope of the present invention.

What is claimed is:

1. A computer-implemented method of providing illustrations of college expense funding for a plurality of college students who attend an institution of higher education and who pay at least some college expenses using proceeds from parental college-related loans, wherein payments on the loans are reimbursed by the institution only if the student does not drop out of the institution, the method comprising:
(a) inputting into a computer:
(i) current budget amount of the institution that is available for scholarships for a class year of students,
(ii) number of scholarships that the institution plans on funding,
(iii) dropout rates for each of the class years of the institution,
(iv) loan rate and loan terms for parental college-related loans, and
(v) an assumed return on investment of the amount of the current budget amount;
(b) calculating in a computer program, at least one of the following items using at least the inputted items in (a)(i)-(v):
(i) loan amounts that can be awarded by the institution in lieu of scholarships based on the current budget amount,
(ii) a drawback amount,
(iii) added income from retention,
(iv) total funds used by the institution, and
(v) a plan termination date; and
(c) outputting an illustration that shows at least one of the items calculated in step (b).

2. The method of claim 1 wherein the loan terms include a discharge feature, and step (a) further includes inputting:
(vi) estimated average age of parents of the students receiving scholarships, wherein the calculation in step (b) factors in the discharge feature.

3. The method of claim 1 wherein step (a) further includes inputting:
(vi) administrative fees,
wherein the calculation in step (b) factors in the administrative fees.

4. The method of claim 1 wherein the parental college-related loans are PLUS loans.

5. A computer-implemented apparatus for administering a financial aid program for a plurality of students who attend one or more institutions of higher education and who pay at least some college expenses using proceeds from parental college-related loans, wherein payments on the loans are reimbursed by the institution only if the student does not drop out of the institution, the apparatus comprising:
(a) a database that maintains:
(i) parental college-related loan data, including student and parent identification information regarding the parental loans,
(i) student enrollment and dropout data, and
(ii) payment obligation data of the one or more institutions regarding the loans; and
(b) an administration computer connected to the database that includes a payment module that makes loan payment authorizations for the one or more institutions in accordance with their respective payment obligation data for causing such payment obligations to be fulfilled.

6. The apparatus of claim 1 wherein the parental college-related loans are PLUS loans.
